(19) United States
(12) Patent Application Publication
(10) Pub. No.: US 2015/0106150 A1
(43) Pub. Date: Apr. 16, 2015

(54) SYSTEM AND METHOD FOR MANAGING EVENT PARTICIPANT AUTHORIZATIONS

(71) Applicant: Kastle Systems International LLC, Falls Church, VA (US)

(72) Inventor: Mohammad Soleimani, Potomac, MD (US)

(21) Appl. No.: 14/515,181

(22) Filed: Oct. 15, 2014

Related U.S. Application Data
(60) Provisional application No. 61/891,077, filed on Oct. 15, 2013.

(51) Int. Cl. G06Q 10/10; H04L 29/06

(52) U.S. Cl. CPC G06Q 10/1095; G06Q 10/107; H04L 63/08
USPC 705/7.19; 726/4

(57) ABSTRACT

According to aspects of the present disclosure, a system for managing authorization of one or more event participants to access a facility includes one or more controllers and one or more memory devices storing instructions. When executed by the one or more processors, the instructions cause the system to receive a first e-mail including a plurality of parameters associated with an event. The plurality of parameters includes an e-mail address associated with each of one or more participants for attending the event. The first e-mail is generated by a calendar application associated with an event organizer. The instructions further cause the system to process the received first e-mail to determine the plurality of parameters, store the determined plurality of parameters in a database, and authorize at least one of the one or more participants to access the facility based on the plurality of parameters.

### CROSS-REFERENCE TO RELATED APPLICATION

This application claims the benefit of U.S. Provisional Patent Application No. 61/891,077, filed Oct. 15, 2013, entitled “System and Method for Managing Event Participant Authorizations” which is hereby incorporated by reference in its entirety.

### FIELD OF THE INVENTION

The present invention relates generally to systems and methods for event scheduling and, more particularly, to systems and methods for managing participant authorizations to access a secured premises for an event.

### BACKGROUND OF THE INVENTION

Meetings are often scheduled using electronic scheduling tools. For example, calendar applications allow users to schedule and coordinate appointments, meetings, and other events. Such calendar applications are typically capable of providing reminders to the calendar application user in advance of a scheduled appointment, meeting, or event, and may also transmit scheduling information to other users over a network, such as a local area network or the Internet. MICROSOFT OUTLOOK, for example, provides the user with means to invite one or more potential participants to join a meeting via a meeting request e-mail sent to the e-mail addresses of the invited persons.

Frequently, scheduled meetings take place in facilities to which access is controlled or restricted for non-tenants. To facilitate the process of authorizing a visitor to enter such facilities, a visitor management system may be employed. Prior to the meeting, a tenant provides information to the visitor management system about the visitors and/or the scheduled event. Upon arrival at the facility, the visitors typically check-in at a security desk to gain access to the facility. Using the visitor management system, the security personnel verify the identity of the non-tenant visitors and determine whether the visitors have been authorized to enter the building.

Known visitor management systems suffer from a number of drawbacks. In particular, for example, the visitor management systems used by building security are often implemented independently of the calendar application that is used to schedule the event with the participants. As a result, the meeting organizer is required to separately and independently enter information about the event and the event participants into two different systems to schedule the event and inform building personnel that visitors are authorized to enter the premises for the event. Not only is this an inefficient process, it requires the user to be trained on two different systems. Moreover, if the event and/or the event participants change, the user must ensure that two different systems are updated accordingly. If the event organizer changes the event details via the calendar application but neglects to update the visitor management system, a visitor may be denied access or at least delayed in arriving for a scheduled event. Thus, in known visitor management systems, the user provides the function of a human interface between the calendar application and the security apparatus at the facility.

### SUMMARY OF THE INVENTION

According to one aspect of the present invention, a system for managing authorization of one or more event participants to access a facility includes one or more controllers and one or more memory devices storing instructions. When executed by the one or more processors, the instructions cause the system to receive a first e-mail including a plurality of parameters associated with an event. The plurality of parameters includes an e-mail address associated with each of one or more participants for attending the event. The first e-mail is generated by a calendar application associated with an event organizer. The instructions further cause the system to process the received first e-mail to determine the plurality of parameters, store the determined plurality of parameters in a database, and authorize at least one of the one or more participants to access the facility based on the plurality of parameters.

According to another aspect of the present invention, a method for managing authorization of one or more event participants to access a facility includes receiving, at a host e-mail address, a first e-mail including a plurality of parameters associated with an event. The plurality of parameters includes an e-mail address associated with each of one or more participants for attending the event. The first e-mail is generated by a calendar application associated with an event organizer. The method also includes processing, using one or more controllers, the received first e-mail to determine the plurality of parameters, storing the determined plurality of parameters in a database, and authorizing at least one of the one or more participants to access a facility based on the plurality of parameters.

According to yet another aspect of the invention, computer-readable storage media is encoded with instructions for directing a system to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of a system for managing event participant authorizations according to aspects of the present disclosure.

FIG. 2 is a block diagram of a client computing device according to aspects of the present disclosure.

FIG. 3 is a flowchart for a process of managing event participant authorization according to aspects of the present disclosure.

FIG. 4 is an exemplary confirmation e-mail according to aspects of the present disclosure.

FIG. 5 is a flowchart for a process of managing event participant authorization according to additional aspects of the present disclosure.

FIG. 6 is an exemplary e-mail for initiating a registration process according to aspects of the present disclosure.

FIG. 7 is an exemplary webpage for registering a user according to aspects of the present disclosure.

FIG. 8 is an exemplary e-mail for initiating a confirmation process according to aspects of the present disclosure.

FIG. 9 is an exemplary webpage for a confirmation process according to aspects of the present disclosure.

FIG. 10 is an exemplary webpage for a confirmation process according to aspects of the present disclosure.

FIG. 11 is an exemplary post-confirmation e-mail according to aspects of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

In accordance with aspects of the present disclosure, systems and methods are provided that automatically facilitate visitor authorization to enter a secured premises for scheduled events. In particular, utilizing the systems and methods of the present disclosure, a user invites visitors to an event and authorizes the visitors to enter a premise of controlled access through an automatic extension of a calendar invite workflow.

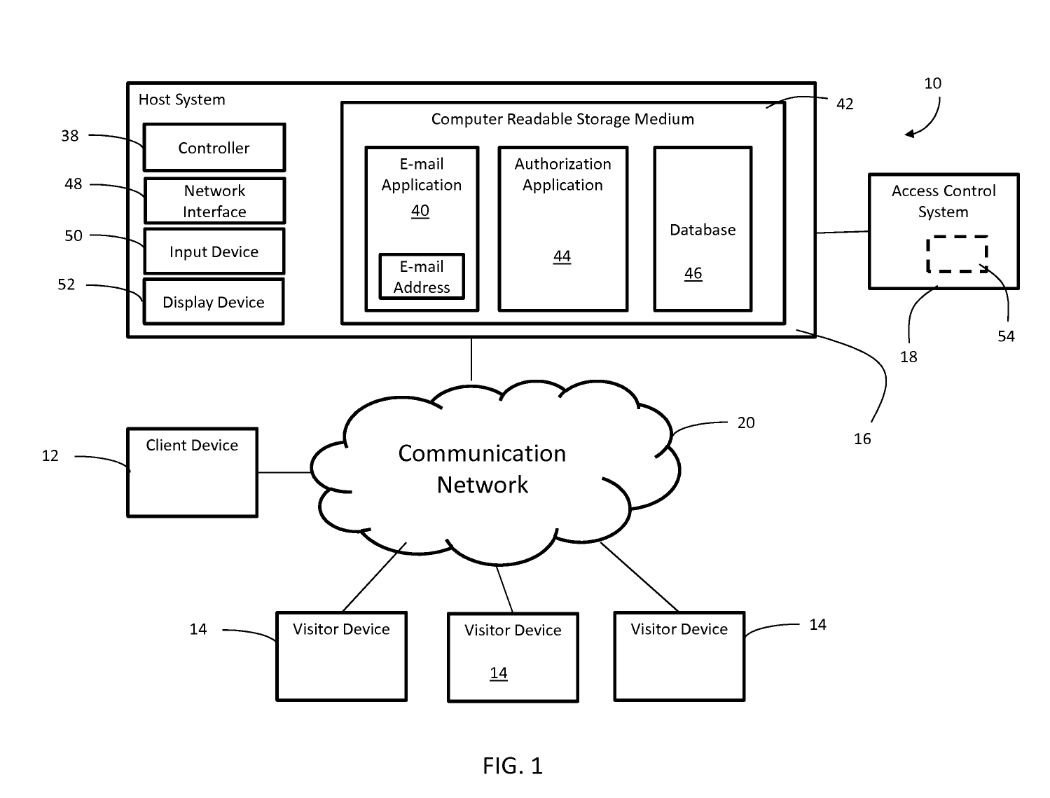

Referring to FIG. 1, there is shown a block diagram of an exemplary system 10 for managing event participant authorizations according to aspects of the present disclosure. The system 10 includes a client computing device 12, one or more visitor computing devices 14, a host system 16, and an access control system 18. The one or more client computing devices 12, the one or more visitor computing device 14, and the host system 16 are communicatively coupled to a communications network 20 such as, for example, the Internet. The host system 16 is further in communication with the access control system 18. According to some aspects of the present disclosure, the host system 16 can be communicatively coupled to the access control system 18 over a private network for security purposes. It is contemplated that the communications networks can include suitable wired and/or wireless networks such as, for example, the Internet, an intranet, a LAN network, a WAN network, a PSTN network, near-field communications, Bluetooth, combinations thereof, and/or the like.

The client computing device 12 includes a combination of hardware and software operable to run a calendar application 24. For example, the client computing device 12 can include a desktop computer, a laptop computer, a personal data assistant (PDA) device, a mobile phone, a network of computers, combinations thereof, and/or the like. The calendar application 24 is operable to send and receive e-mails via the e-mail address of a user of the calendar application 24. In the illustrated example, the client computer device 12 is associated with a user (i.e., an event organizer) that utilizes the calendar application 24 to schedule an event 26 by transmitting an event e-mail, requesting the attendance of other participants (i.e., invitees) associated with the one or more visitor computing devices 14 at a facility associated with the host system 16, as will be described in greater detail below.

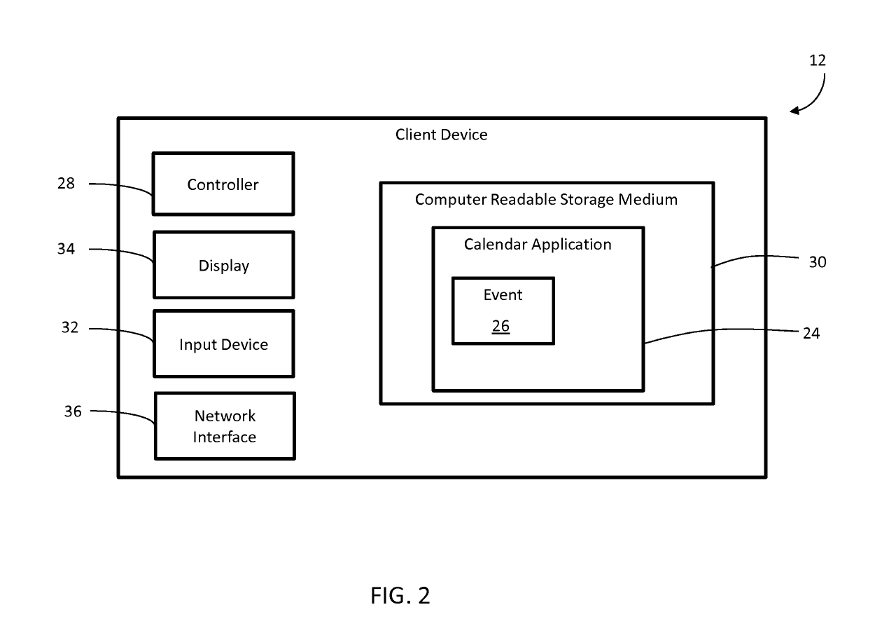

Referring to FIG. 2, a block diagram of an exemplary client computing device 12 is illustrated. The client computing device 12 includes a controller 28 operable to execute the calendar application 24 based on one or more program instructions stored in a computer-readable storage media 30. The calendar application 24 is an electronic calendar containing events such as, for example, the event 26 illustrated in FIG. 2. As used herein, the term “event” refers to data objects being stored in, written to or read from an electronic calendar of a calendar application 24, the data objects representing an event in the real world. The data object comprises data being adapted to specify an event 26. For example, an event 26 in an electronic calendar may comprise a starting time, an ending time, a location, the subject, and/or the participants (i.e., the event organizer and the invitees). The data object can be manipulated by the commands of a programming language. An event 26 can be a singular event or a recurring event comprising a particular recurrence pattern.

The client computing device 12 can also include one or more input devices 32 for receiving input data from the user (e.g., a keyboard, a mouse, a touch screen, etc.), one or more display devices 34 (e.g., a CRT monitor, an LED display, a touch screen, etc.) for displaying information to a user, and one or more network interfaces 36 that are operable to facilitate data communications with the host system 16 and/or the visitor computing devices 14 over the communications network 20.

The one or more visitor computing devices 14 include hardware and/or software configured to receive the event e-mail from the client computing device 12 via the communications network 20 and display the event e-mail to an associated user of the visitor computing device(s) 14. In particular, the event e-mail is received by each invitee via respective e-mail addresses and viewed by the invitees via an e-mail application installed on each of the one or more visitor computing devices 14. Accordingly, the one or more visitor computing devices 14 can include one or more controllers operable to execute the e-mail application, computer-readable storage media operable to store one more program instructions for executing the e-mail application, display devices for displaying information to the invitee(s), input devices for receiving data inputs from the invitee(s), and/or network interfaces for communicating with the communications network 20. As non-limiting examples, the one or more visitor computing devices 14 can also include desktop computers, laptop computers, handheld computing devices, personal data assistant (PDA) devices, mobile phones, a network of computers, combinations thereof, and/or the like.

As described above, the host system 16 is associated with a controlled access facility in which the event 26 is scheduled to occur. The facility can be a location associated with the event organizer's place of business, a location associated with one or more of the invitees' places of business, or a third party location not associated with the event organizer or the invitees. The host system 16 can be located entirely on the premises of the controlled access facility or in part located remotely from the premises of the controlled access facility.

The host system 16 is also configured to receive the event e-mail from the client computing device 12 (e.g., via the communications network 20). In particular, the host system 16 is configured to receive the event e-mail at a host e-mail address associated with the host system 16. The host system 16 can thus include one or more controllers 38 operable to execute an e-mail application based on one or more program instructions stored in one or more computer-readable storage media 42.

The controller of the host system 16 is further operable to execute a participant authorization application 44 based on program instructions stored in the one or more computer-readable storage media 42. The participant authorization application 44 is configured to process the event e-mail to execute a process for authorizing access to the secured facility for the invitees of the event 26, as will be described in greater detail below. The one or more computer-readable storage media 42 of the host system 16 can further include a database 46 for storing data generated by the authorization application 44.

Additionally, the host system 16 can include one or more network interfaces 48 for communicatively coupling the host system 16 to the communications network, one or more input devices 50, and/or one or more display devices 52.

The access control system 18 restricts physical access to a secured area in the facility (in which the event 26 is scheduled to occur) to authorized persons. The access control system 18 can achieve access control by human and/or technological means. As non-limiting examples, the access control system 18 can include a locked door, a turnstile (e.g., a waist-high turnstile, a full-height turnstile, an optical turnstile, etc.), a secured revolving door, a security portal, an access gate, a locked elevator, other physical barriers, a security desk operated by security personnel, a receptionist, combinations thereof, and/or the like.

The access control system 18 is configured to receive credential information from persons attempting to enter the secured area of the facility and, based on the received credential information, allow or restrict access to the secured area of the facility. According to some aspects of the present disclosure, the access control system 18 is configured to communicate the received credential information to the host system 16, which determines whether the presenter of the credential information is authorized (e.g., by comparing the credential information against predetermined authorization information stored in the database 46). In response to the determination, the host system 16 provides a control signal to the access control system 18 indicating whether the presenter of the credentials is authorized to access the secured area of the facility. Based on the control signal, the access control system 18 allows or continues to restrict access to the secured area of the facility. According to additional and/or alternative aspects of the present disclosure, the access control system 18 can be configured to locally determine whether to allow or restrict access based on the credential information received at the access control system 18. For example, the access control system 18 can store in memory authorization information received from the host system 16 against which the received credential information can be compared to determine whether the presenter of the credentials is authorized to access the secured area of the facility.

According to some aspects, the access control system 18 can include one or more readers 54 for receiving the credential information such as, for example, a keypad, a card reader, a barcode reader, a biometric scanner, a RFID reader, a Bluetooth reader, a microphone for voice recognition, other sensors, combination thereof, and/or the like. The credential information can take the form of, for example, a password, an alphanumeric code, a biometric measurement (e.g., a fingerprint, an iris, a retina, etc.), an identification card (e.g., a driver's license, building identification card, etc.), a barcode, a RFID chip, a smart card, an electronic data file, a key-fob, a magnetic stripe, combinations thereof, and/or the like. It is contemplated that the access control system 18 can also include an output device (not shown) configured to provide a feedback indication as to whether the person is authorized to enter the secured area. For example, the access control system 18 can include an indicator light, an audio speaker, a display monitor, or any other device suitable for providing an auditory and/or visual indication as to whether the person is authorized to access the secured area.

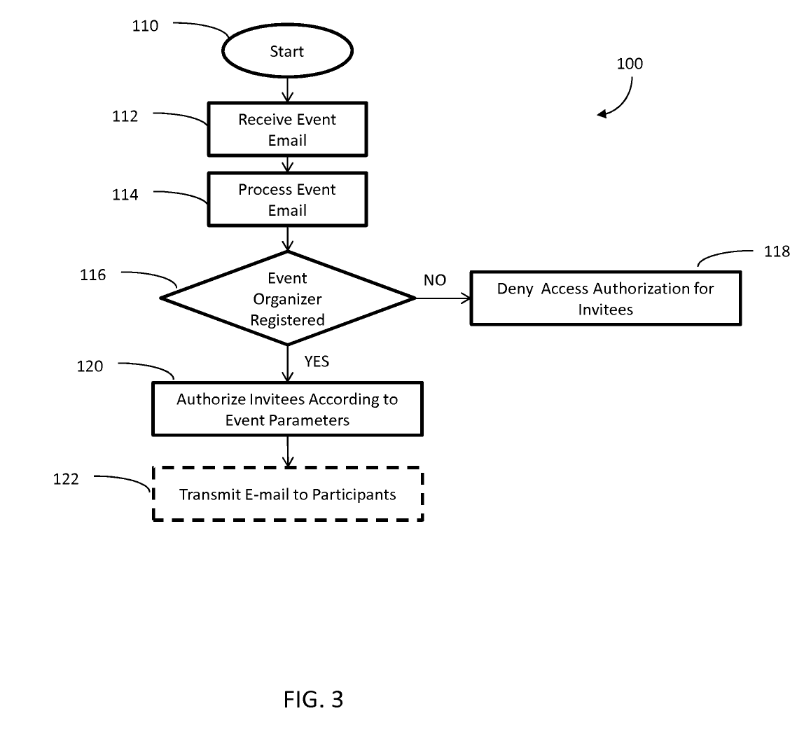

The operation of the system 10 will now be described. Referring to FIG. 3, an exemplary flowchart for a process 100 of managing event participant authorization is illustrated. The process 100 is initiated at block 110 when the user associated with the client computing device 12 (i.e., the event organizer) utilizes the calendar application 24 to generate and transmit an event e-mail, including a plurality of event parameters, to the e-mail addresses associated with the other participants of the event 26 (i.e., the invitees) and the host system 16. The event parameters can include a starting time, an ending time, a location, the subject, and/or the participants of the event 26. According to some aspects, the calendar application 24 can provide the event organizer with an interface via the display device 34 that prompts the event organizer to enter the event parameters into respective data fields using the input device 32. As described above, the invitees can be specified by their e-mail addresses entered, for example, in the “to” data field of the event e-mail while the event organizer is specified by the e-mail address in the “from data field. The event e-mail can be formatted and transmitted by the calendar application 24 according to known techniques such as, for example, Simple Mail Transfer Protocol (SMTP), RFC 2822 (Request for Comment 2822 published by the Internet Society, “Internet Message Format”), Multipurpose Internet Mail Extension (MIME), or a similar format.

At block 112, the host system 16 receives the event e-mail at the host e-mail address. At block 114, the host system 16 automatically processes the event e-mail to parse the event parameters via the authorization application 44. In implementations in which the event parameters are entered in predefined data fields, the authorization application 44 can determine the event parameters via an analysis of the relevant data fields (e.g., the “start time” data field, the “end time” data field, the “subject” data field, the “location data field”, the “to” data field, and/or the “from” data field). In additional and/or alternative implementations, the authorization application 44 analyze all fields of the event e-mail including, for example, the body of the event e-mail to identify information that may be relevant to scheduling and authorization aspects of the event 26. For example, one or more algorithms can be implemented to identify relevant information such as locations, times, participants, and subjects of an event from the body of the event e-mail. The event parameters determined by host system 16 via the authorization application 44 can be stored in a database 46 of the host system 16.

At decision block 116, it is determined whether the event organizer is registered with the host system 16 and, thus, has authority to authorize visitors to access the secured area of the facility. For example, the authorization application 44 can identify the event organizer based on the e-mail address indicated in the “from” data field of the event e-mail and compare this event parameter information against a list of registered users stored in the memory 42 of the host system 16. If it is determined at decision block 116 that the event organizer is not a registered user, the host system 16 denies authorization for the invitees to access the secured area of the facility at block 118. Optionally, the host system 16 can be configured to transmit an e-mail to the e-mail address of the event organizer indicating that the request for access authorization was denied because the event organizer has not registered or is not themselves authorized to grant the invitees access to the secured area of the facility.

On the other hand, if it is determined that the event organizer is registered at block 116, then the host system 16 authorizes the invitees to access the secured area of the facility at block 120 according to the event parameters determined at block 114. For example, the host system 16 can authorize access for the invitees at the specified start time indicated in the event e-mail or within a time window based on the specified start date (e.g., within one hour of the scheduled start time indicated in the event e-mail).

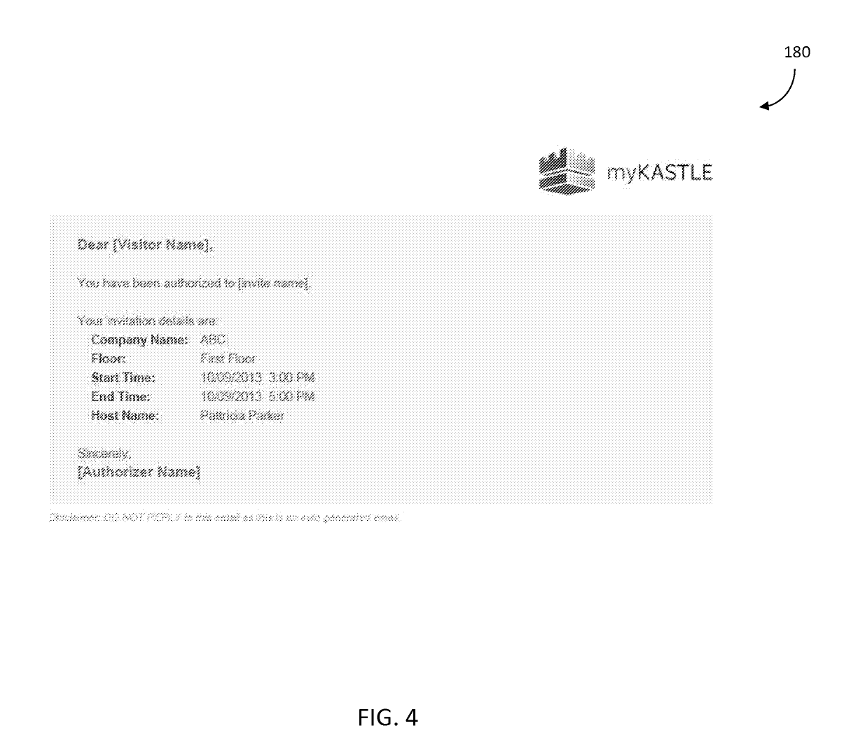

Optionally, at block 122, a confirmation e-mail can be generated and transmitted by the host system 16 to the participants (i.e., the event organizer and/or the invitees) to confirm details of the scheduled event, provide information for entering the secured area of the facility, and/or provide credentials to the participants for accessing the secured area of the facility. For example, the confirmation e-mail can include a barcode that the invitee can present a mobile phone to a barcode reader at the access control system 18 to allow the invitee to access the secured area and attend the event 26. As another example, the confirmation e-mail can include a passcode that the invitee enters on a keypad to enter the secured area and attend the event 26. As still another example, the confirmation e-mail can include instructions for presenting an identification card (e.g., a driver's license) to security personnel at a security desk. FIG. 4 illustrates a non-limiting example of a confirmation e-mail 180 that can be sent to the invitees' e-mail addresses by the host system 16.

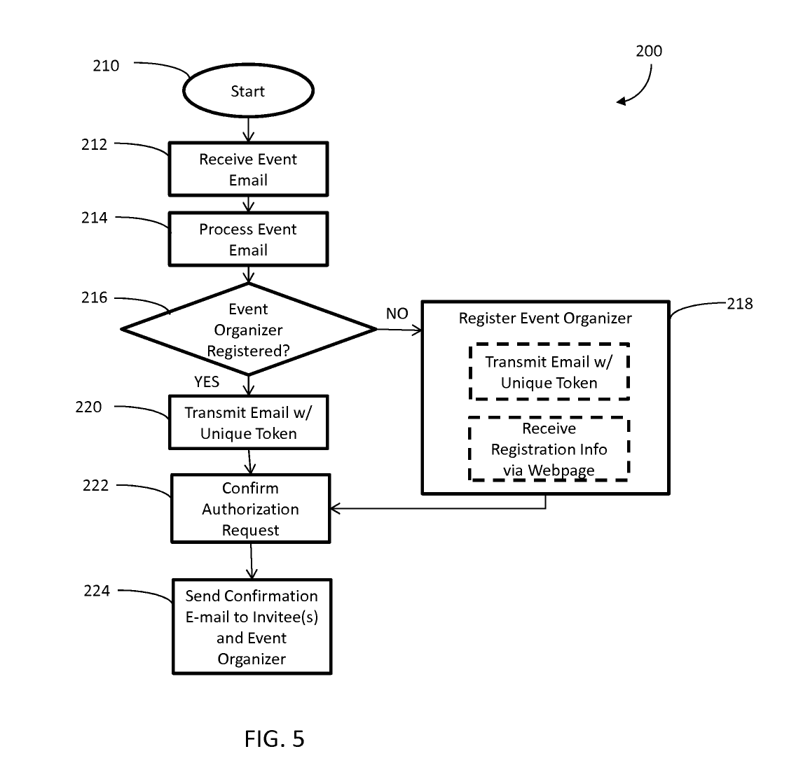

Referring now to FIG. 5, a flowchart of another exemplary process 200 for managing event participant authorizations is illustrated. Advantageously, the process 200 includes a number of additional features that provide significant security improvements. In particular, the process 200 is configured to ensure that the event organizer is not only registered with the host system 16 and thus permitted to authorize access by the invitees, but also that the event organizer is the person whom in fact made the request to authorize access for the invitees.

The process 200 is initiated when the event organizer transmits an event e-mail to the e-mail addresses of the invitees and the host e-mail address at block 210 as described above. At block 212, the host system 16 receives the event e-mail and, at block 214, the host system 16 processes the event e-mail via the authorization application 44 as described above with respect to blocks 112 and 114 for the process 100 of FIG. 3. At block, 216, it is determined whether the event organizer is registered with the host system 16 based on the event organizer's e-mail address in the “from” data field. If the event organizer is not registered, the host system 16 initiates a process for registering the event organizer at block 218.

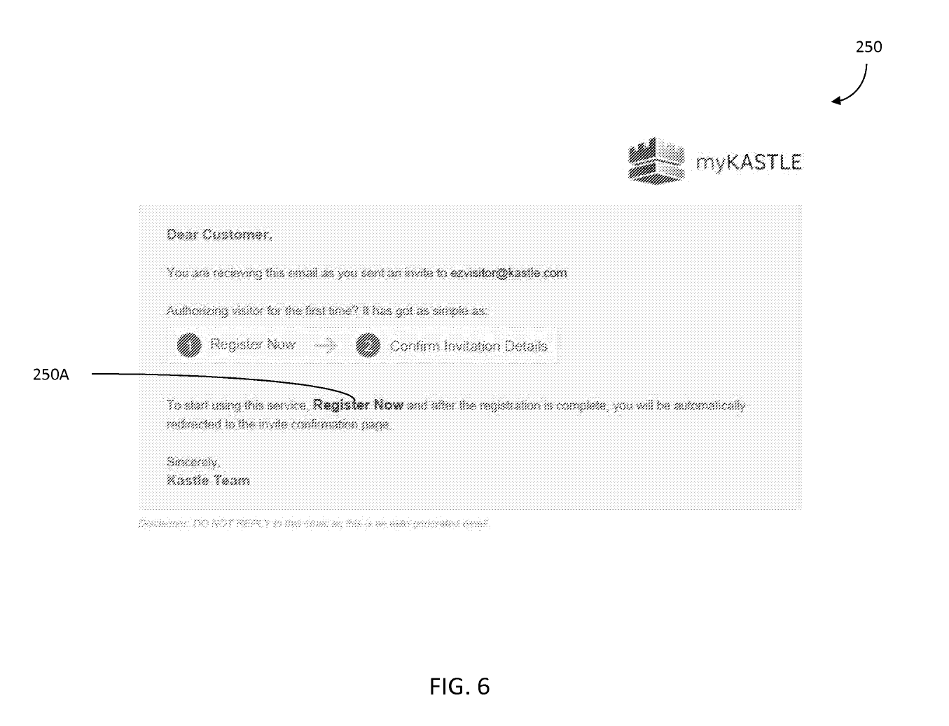

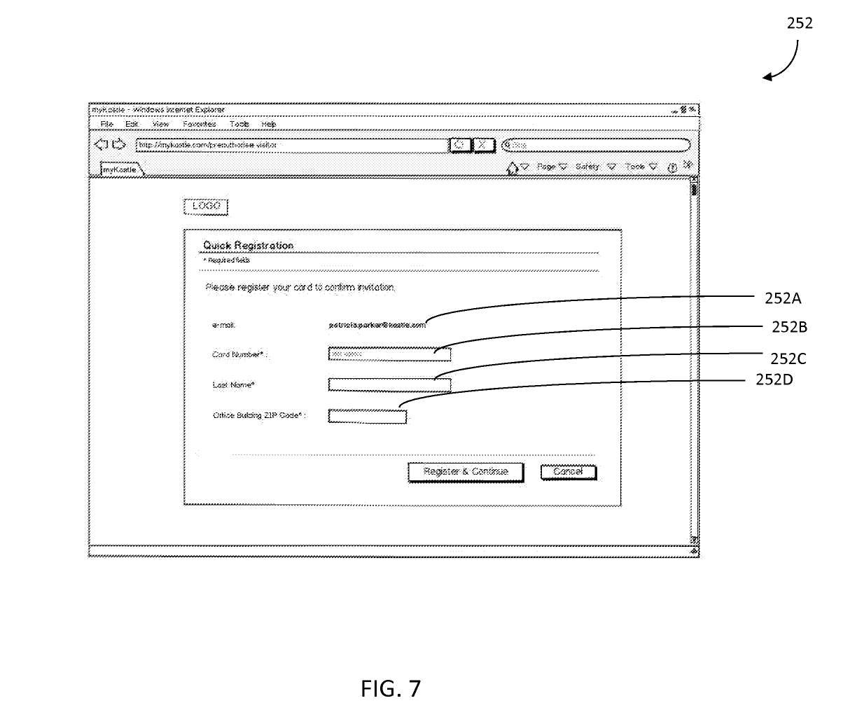

According to one exemplary implementation, the host system 16 sends a registration e-mail to the e-mail address of the event organizer including a URL link to a webpage for registration. FIG. 6 illustrates a non-limiting example of a registration e-mail 250 that the host system 16 can send to the e-mail address of the event organizer Clicking on the URL link 250A labeled “Register Now”, causes the client computing device 12 to display a webpage (e.g., via a web browser application) including a plurality of fields for entering information required to register the event organizer with the host system 16. According to some aspects of the present disclosure, the URL link 250A can include a unique token for security purposes. FIG. 7 illustrates a non-limiting example of a webpage 252 that can be utilized to register the event organizer. As shown in FIG. 7, the e-mail address field 252A can be automatically populated to include the e-mail address of the event organizer from which the event e-mail was transmitted in block 210. The registration webpage 252 can also include one or more data fields 252A-252D to verify the event organizer's identity, authorization to provide access to the secured area of the building, and the organization with which the event organizer is affiliated. For example in FIG. 7, the registration webpage 252 requires that the event organizer enter their last name 252C, the zip code of the facility 252D, and the card number 252B for an access card issued by the facility's security personnel to the event organizer, which allows the event organizer to themselves enter the secured area of the facility. In instances in which a card number is utilized, the host system 16 can utilize the card number to determine additional information associated with the event organizer based on information previously stored in the computer-readable media 42 of the host system 16 in association with the card number. For example, the host system 16 can determine which organizations (or secured area(s)) the event organizer has authority to authorize access to.

While the above example is described and illustrated in terms of an e-mail 250, a URL link 250A and a webpage 252 for registering the event organizer, it is contemplated that, according to additional and/or alternative aspects of the present disclosure, the event organizer can be prompted to provide information for registration via fax, telephone, and/or in person in addition or in the alternative to an e-mail and webpage as described above. After the event organizer has been registered at block 218, the process 200 proceeds to block 222.

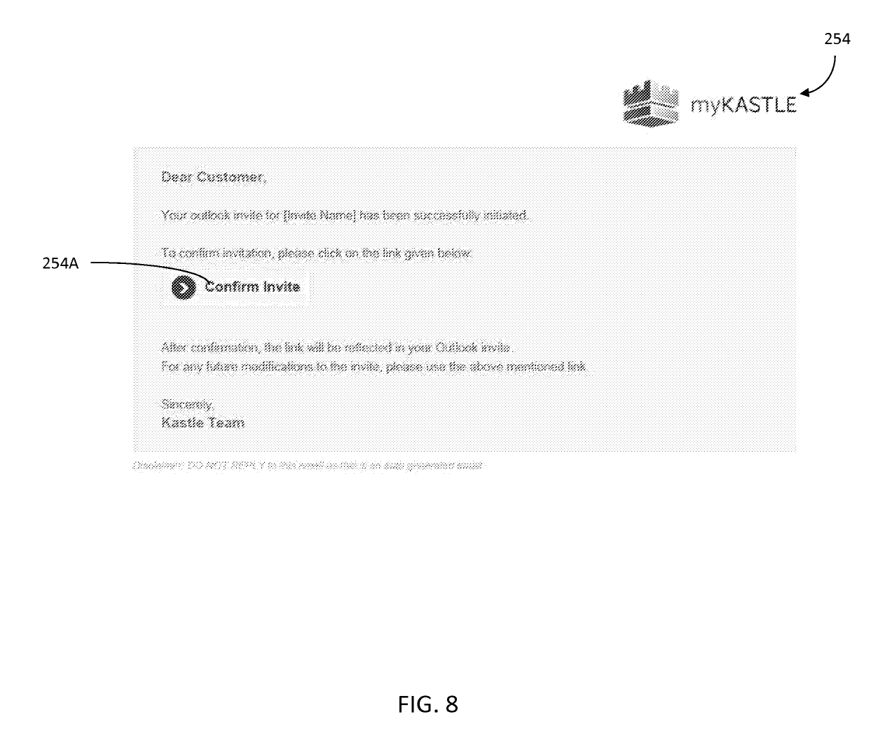

If it is determined that the event organizer is registered at block 216, then the event organizer is requested to confirm the request for authorization. In this way, the host system 16 can authenticate that the request was in fact initiated by the event organizer (i.e., and not in the furtherance of a security breach). As one non-limiting example, at block 220 an e-mail can be sent from the host system 16 to the e-mail address of the event organizer requesting that the event organizer confirm the request for authorization. The e-mail sent at block 220 can include a URL link to a webpage for confirming the event. FIG. 8 illustrates a non-limiting example of a confirmation e-mail 254 that can be sent at block 220. Clicking on the URL link 254A labeled “Confirm Invite”, causes the client computing device 12 to display one or more webpages for confirming an authorization request for the event 26 at block 222. It is contemplated that the URL link 254A can include a unique token for security purposes.

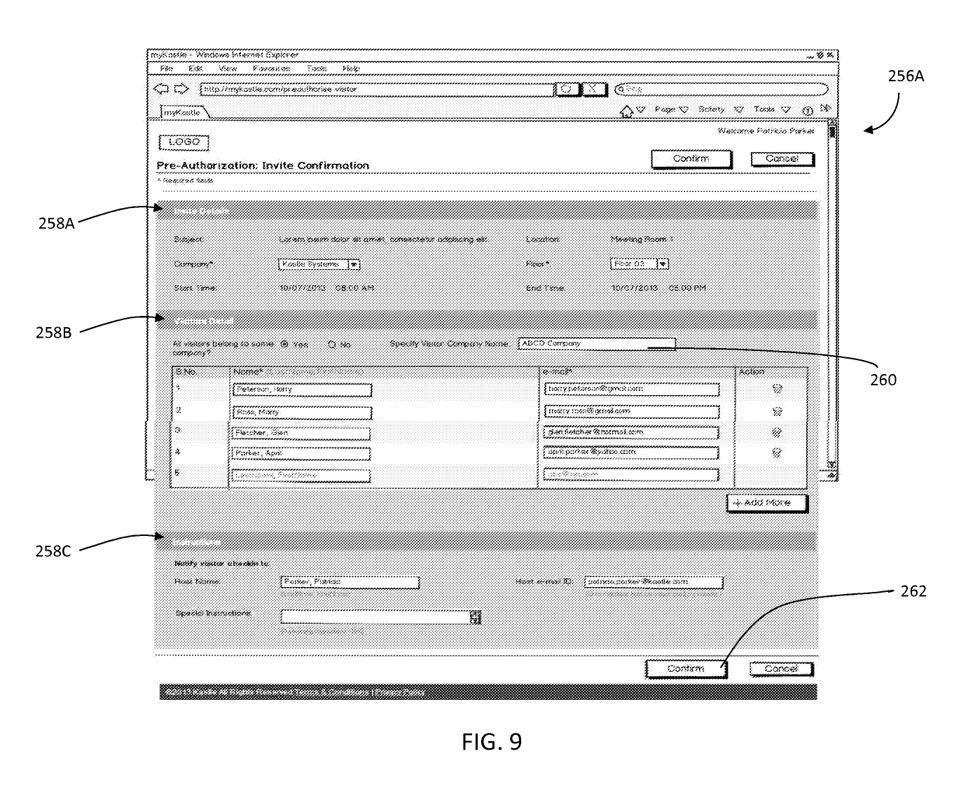

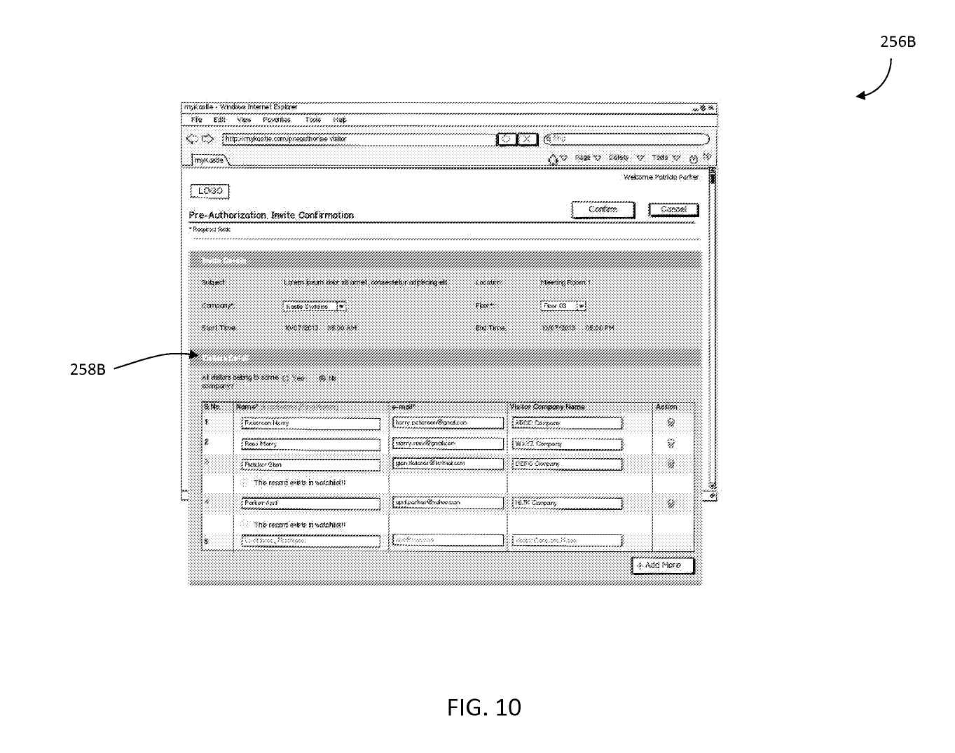

FIGS. 9-10 illustrate non-limiting examples of webpages 256A, 256B that can be utilized to confirm the request for authorization for participant access at block 222. The exemplary webpages 256A, 256B include three different sections of information: (1) invite details 258A, (2) visitor details 258B, and (3) instructions 28C. The invite details section 258A includes the event parameter information determined by the host system 16 at block 214. According to some aspects, the event parameter information may not be editable. According to alternative aspects, the event parameter information can be edited. The company information and the floor information can be edited. The company information can include a drop-down menu that is populated with the company names and floors for which the event organizer is authorized to grant access. As described above, the company and floor information can be determined when the event organizer is registered.

In the visitor information section 258B, the event organizer can specify whether the invitees are coming from the same company. According to the illustrated example, if the invitees belong to the same company, then a single data entry field for specifying the company 260 is provided. In the instructions information section 258C, the host name and host e-mail ID can be automatically filled based on the event parameter determined in block 214 for the “from” data field of the event e-mail and the file for the registered event organizer stored in the database 46.

While FIG. 9 illustrates the webpage 256A with an option selected to indicate that all invitees are coming from the same company, FIG. 10 illustrates the webpage 256B with the option selected to indicate that not all invitees are coming from the same company. As illustrated in FIG. 10, the visitor information section 258B can include additional data fields for entering the company associated with each invitee.

It is contemplated that the visitor information section 256B can be edited to allow the event organizer to add or delete invitees for which authorization is to be provided. Additionally, it is contemplated that the authorization application 44 can be configured to analyze the list of invitees to determine whether any of the invitees do not require authorization to enter the secured area of the facility. For example, if one or more of the invitees are also registered users of the system 10, authorization may not be required for such invitees. In such instances, the webpage 256A, 256B can be configured to indicate that visitor information is not required for such invitees.

Still further it is contemplated that, according to some aspects of the present disclosure, the host system 16 can be configured to determine whether any of the invitees should be flagged for additional scrutiny. For example, the host system 16 can maintain a watch list in the database 46 against which the list of invitees' e-mail addresses are compared to determine whether to flag one more of the invitees. As shown in the example illustrated in FIG. 10, two of the invitees have been flagged as being on the watch list.

The confirmation process of block 222 concludes when the event organizer actuates the confirm button 262. The process 200 then proceeds to block 224 at which a confirmation e-mail is transmitted by the host system 16 to each e-mail address associated with the invitees, as explained above with respect to block 122 and illustrated in FIG. 4. Additionally, at block 224, a confirmation e-mail can be sent to the e-mail address associated with the event organizer.

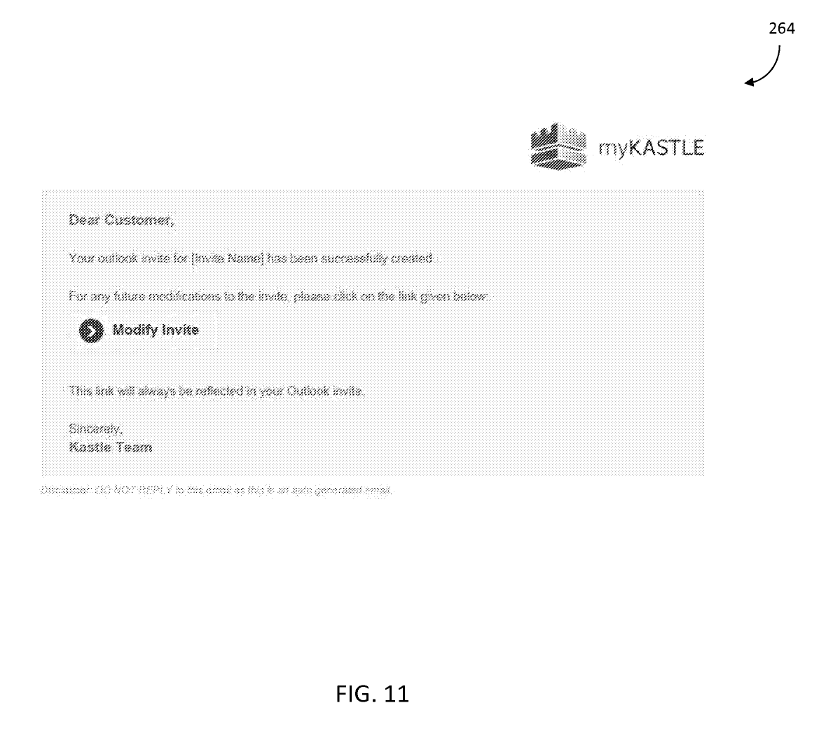

Optionally, the host system 16 can be configured to also send a post-confirmation e-mail to the event organizer after the confirmation process is concluded at block 222. The post-confirmation e-mail can include another URL link to a webpage that allows the event organizer to modify the information previously provided via the confirmation process at block 222. FIG. 11 illustrates a non-limiting example of a post-confirmation e-mail 264.

FIGS. 3 and 5, described by way of example above, represent exemplary algorithms that correspond to at least some instructions executed by the CPU 38 in FIG. 1 to perform the above described functions associated with the described concepts. It is also within the scope and spirit of the present concepts to omit steps, include additional steps, and/or modify the order of steps presented above.

As described above, the present disclosure includes systems having controllers for providing various functionality to process information and determine results based on inputs. Generally, the controllers may be implemented as a combination of hardware and software elements. The hardware aspects may include combinations of operatively coupled hardware components including microprocessors, logical circuitry, communication/networking ports, digital filters, memory, or logical circuitry. The controller may be adapted to perform operations specified by a computer-executable code, which may be stored on a computer-readable storage media.

As described above, the controller 38 may be a programmable processing device, such as an external conventional computer or an on-board field programmable gate array (FPGA) or digital signal processor (DSP), that executes software, or stored instructions. In general, physical processors and/or machines employed by embodiments of the present disclosure for any processing or evaluation may include one or more networked or non-networked general purpose computer systems, microprocessors, field programmable gate arrays (FPGA's), digital signal processors (DSP's), micro-controllers, and the like, programmed according to the teachings of the exemplary embodiments of the present disclosure, as is appreciated by those skilled in the computer and software arts. Appropriate software can be readily prepared by programmers of ordinary skill based on the teachings of the exemplary embodiments, as is appreciated by those skilled in the software art. In addition, the devices and subsystems of the exemplary embodiments can be implemented by the preparation of application-specific integrated circuits or by interconnecting an appropriate network of conventional component circuits, as is appreciated by those skilled in the electrical art(s). Thus, the exemplary embodiments are not limited to any specific combination of hardware circuitry and/or software.

Stored on any one or on a combination of computer-readable storage media, the exemplary embodiments of the present disclosure may include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer-readable storage media further can include the computer program product of an embodiment of the present disclosure for performing all or a portion (if processing is distributed) of the processing performed in implementations. Computer code devices of the exemplary embodiments of the present disclosure can include any suitable interpretable or executable code mechanism, including but not limited to scripts, interpretable programs, dynamic link libraries (DLLs), Java classes and applets, complete executable programs, and the like. Moreover, parts of the processing of the exemplary embodiments of the present disclosure can be distributed for better performance, reliability, cost, and the like.

Common forms of computer-readable media 44 may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects. For example, while the client computing device 12 is communicatively coupled to the host system 16 over the same communications network 20 (e.g., the Internet) as the visitor computing devices 14 in the example illustrated in FIG. 1, it should be understood that the client computing device 12 can be communicatively coupled to the host system 16 over a different communications network (e.g., a LAN network, an intranet, a private network, etc.).

What is claimed is:

1. A system for managing authorization of one or more event participants to access a facility, comprising:
one or more controllers;
one or more memory devices storing instructions that, when executed by the one or more processors, cause the system to:
receive a first e-mail including a plurality of parameters associated with an event, the plurality of parameters including an e-mail address associated with each of one or more participants for attending the event, the first e-mail being generated by a calendar application associated with an event organizer;
process the received first e-mail to determine the plurality of parameters;
store the determined plurality of parameters in a database; and
authorize at least one of the one or more participants to access the facility based on the plurality of parameters.

2. The system of claim 1, wherein the instructions further cause the system to:
determine whether the event organizer is a registered user;
generate a URL based on the determination of whether the event organizer is a registered user; and
transmit a second e-mail to an e-mail address associated with the event organizer including the URL.

3. The system of claim 2, wherein the URL provides a link to a webpage configured to register the event organizer if it is determined that the event organizer is not a registered user.

4. The system of claim 2, wherein the URL provides a link to a webpage configured to confirm the event if it is determined that the event organizer is a registered user.

5. The system of claim 4, wherein the instructions further cause the system to receive a confirmation of the event from the event organizer via the webpage.

6. The system of claim 5, wherein the instructions further cause the system to transmit a third e-mail to the e-mail address associated with the event organizer including a URL providing a link to a webpage configured to facilitate subsequent modification of one or more of the plurality of event parameters.

7. The system of claim 1, wherein the instructions further cause the system to transmit a confirmation e-mail to one or more e-mail address associated with respective ones of the one or more participants to confirm the event.

8. The system of claim 7, further comprising an access control system configured to control access to a secured area of the facility, the access control system including one or more readers, wherein the confirmation e-mail includes credential information configured to be detected by the one or more readers and indicate authorization.

9. The system of claim 8, wherein the credential information is a barcode.

10. The system of claim 1, wherein the plurality of parameters includes an event start time, an event end time, and a location.

11. The system of claim 1, wherein the instructions further cause the system to determine whether to notify the event organizer of a potential security issue by comparing the e-mail address associated with each participant against a plurality of watch list e-mail addresses stored in the database.

12. A method for managing authorization of one or more event participants to access a facility, comprising:
receiving, at a host e-mail address, a first e-mail including a plurality of parameters associated with an event, the plurality of parameters including an e-mail address associated with each of one or more participants for attending the event, the first e-mail being generated by a calendar application associated with an event organizer;
processing, using one or more controllers, the received first e-mail to determine the plurality of parameters;
storing the determined plurality of parameters in a database; and
authorizing at least one of the one or more participants to access a facility based on the plurality of parameters.

13. The method of claim 1, further comprising:
determining whether the event organizer is a registered user;
generating a URL based on the determination of whether the event organizer is a registered user; and
transmitting a second e-mail to an e-mail address associated with the event organizer including the URL.

14. The method of claim 13, wherein the URL provides a link to a webpage configured to register the event organizer if it is determined that the event organizer is not a registered user.

15. The method of claim 13, wherein the URL provides a link to a webpage configured to confirm the event if it is determined that the event organizer is a registered user.

16. The method of claim 12, further comprising transmitting a confirmation e-mail to one or more e-mail address associated with respective ones of the one or more participants to confirm the event.

17. The method of claim 16, wherein the confirmation e-mail includes credential information configured to be detected by the one or more readers of an access control system, the access control system being configured to control access to a secured area of the facility, the method further comprising:
receiving the credential information;
comparing the received credential information with predetermined authorization information stored in the database; and
granting access to the secured area of the facility, using the access control system, based on the comparison.

18. The method of claim 17, wherein the credential information is a barcode.

19. The method of claim 12, wherein the plurality of parameters includes an event start time, an event end time, and a location.

20. One or more physical machine-readable storage media including instructions which, when executed by one or more processors, cause the one or more processors to perform operations comprising:
receive a first e-mail including a plurality of parameters associated with an event, the plurality of parameters including an e-mail address associated with each of one or more participants for attending the event, the first e-mail being generated by a calendar application associated with an event organizer;
process the received first e-mail to determine the plurality of parameters;
store the determined plurality of parameters in a database; and
transmit a second e-mail to an e-mail address associated with the event organizer including a URL, the URL providing a link to a webpage configured to confirm the event if it is determined that the event organizer is a registered user;
receive a confirmation of the event from the event organizer via the webpage; and
authorize at least one of the one or more participants to access the facility based on the plurality of parameters.
